(19) United States
(12) Patent Application Publication
(10) Pub. No.: US 2008/0246888 A1
(43) Pub. Date: Oct. 9, 2008

(54) METHOD AND APPARATUS FOR RECEIVING AND REPRODUCING BROADCAST DATA BY MEANS OF WIRELESS COMMUNICATION

(75) Inventors: Jae-seuk OH, Seoul (KR); Hyun-seok Choi, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/946,897

(22) Filed: Nov. 29, 2007

(30) Foreign Application Priority Data
Apr. 4, 2007 (KR) 2007-33375

(51) Int. Cl. H04N 5/63

(52) U.S. Cl. 348/730; 348/E05.127

(57) ABSTRACT

A method and apparatus for receiving and reproducing broadcast data by means of wireless communication. When wireless communication is disconnected, by switching to a power saving mode and reproducing a predetermined sound source or image to a user, a sound source or image can be continuously provided to the user, and power can be saved.

### CROSS-REFERENCE TO RELATED APPLICATION

This application claims all benefits accruing under 35 U.S.C. §119 from Korean Patent Application No. 2007-33375, filed in the Korean Intellectual Property Office on Apr. 4, 2007, the disclosure of which is incorporated herein by reference.

### BACKGROUND OF THE INVENTION

1. Field of the Invention

Aspects of the present invention relate to a method and apparatus for receiving and reproducing broadcast data and, more particularly, to a method and apparatus for receiving and reproducing broadcast data by means of wireless communication, which reduces power consumption and continuously provides a sound source or an image to a user even when the broadcast data is not being received smoothly in a shadow area.

2. Related Art

Conventionally, wireless devices are able to receive audio or video broadcast, such as radio, Digital Multimedia Broadcasting (DMB), or streaming audio and/or video, and reproduce the received broadcast in real-time. If the wireless device is operating in a moving vehicle, and the vehicle goes into a shadow area, the connection with a wireless network (wireless Internet, portable Internet, radio, or DMB) may be disconnected, or a reception ratio may drop, making it difficult to view the broadcast program smoothly. A shadow area is an area where wireless communication is unavailable, such as under a bridge, within a building, a forest or a valley, or areas with no wireless access points. In addition, when the connection is disconnected or the reception ratio drops, conventional wireless devices may continue to attempt to communicate with the broadcast station, even though such communication is unnecessary and wastes power.

### SUMMARY OF THE INVENTION

Aspects of the present invention provide a method and apparatus for receiving and reproducing broadcast data by means of wireless communication, by which a sound source or image is continuously provided to a user and power is saved by decreasing power provided to the apparatus for reproducing the broadcast data and reproducing a predetermined sound source or image until the wireless network is reconnected, if it is difficult to receive the broadcast data while the apparatus is operating in a shadow area when the broadcast data is received and reproduced.

Additional aspects and/or advantages of the invention will be set forth in part in the description which follows and, in part, will be obvious from the description, or may be learned by practice of the invention.

According to an aspect of the present invention, a method of receiving and reproducing broadcast data by wireless communication is provided. The method comprises: switching to a power saving mode which uses less electrical power than a mode employed while performing wireless communication, if the wireless communication is disconnected; and reproducing a predetermined sound source or image to a user in the power saving mode.

According to another aspect of the present invention, a computer readable recording medium storing a computer readable program to execute the method of receiving and reproducing broadcast data by wireless communication.

According to another aspect of the present invention, an apparatus to receive and reproduce broadcast data by wireless communication is provided. The apparatus comprises a controller to switch to a power saving mode that uses less electrical power than a mode employed while performing wireless communication, when a wireless network providing the wireless communication is disconnected; and a reproduction unit to reproduce a predetermined sound source or image to a user while the apparatus is operating in the power saving mode.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of an apparatus for receiving and reproducing broadcast data by wireless communication according to an example embodiment of the present invention;

FIG. 2 is a flowchart of a process of receiving and reproducing broadcast data by wireless communication according to an example embodiment of the present invention;

FIG. 3 is a flowchart of a process of receiving and reproducing broadcast data by wireless communication according to an example embodiment of the present invention; and

FIG. 4 is a flowchart of a process of receiving and reproducing broadcast data by wireless communication according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

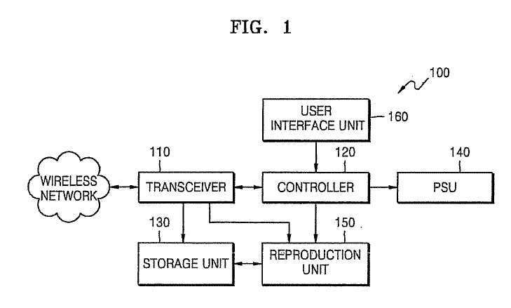

FIG. 1 is a block diagram of a broadcast data reproduction apparatus 100 for receiving and reproducing broadcast data by wireless communication according to an example embodiment of the present invention. The broadcast data reproduction apparatus 100 includes a transceiver 110, a controller 120, a storage unit 130, a power supply unit (PSU) 140, a reproduction unit 150, and a user interface unit 160. According to other aspects of the present invention, the broadcast data reproduction apparatus may include additional and/or different units. Similarly, the functionality of one or more of the above units may be combined into a single component. The broadcast data reproduction apparatus may be a laptop computer, mobile phone, personal digital assistant, personal entertainment device, or other device capable of performing wireless communication.

The transceiver 110 receives broadcast data from a wireless network or attempts to access the wireless network. The wireless network includes wireless Internet, portable Internet, radio, Digital Multimedia Broadcasting (DMB), and/or a cellular network. The broadcast data includes audio and/or video streaming data.

If the connection state of the wireless network is bad or disconnected, the controller 120 outputs a control signal to the PSU 140 for switching to a power saving mode. The controller 120 determines whether a wireless communication reconnection time has elapsed; if the wireless communication reconnection time has elapsed, the controller 120 controls the transceiver 110 to attempt to connect to the wireless network. The power saving mode is a mode in which the amount of electrical power used for wireless communication is reduced to an amount of electrical power enough for the transceiver 110 to perform an operation in response to a control signal for exiting the power saving mode received from the controller 120. The power saving mode uses less electrical power than a mode employed while performing wireless communication.

The storage unit 130 stores connection information (frequency, channel, Uniform Resource Locator (URL), playlist, etc.) of broadcast data being received, if the connection state of the wireless network is bad or disconnected. In addition, when reconnection to the wireless network is achieved, the storage unit 130 stores reproduction information (medium type, file name, reproduced time, etc.) of a sound source or image to be reproduced while the connection state of the wireless network is bad or disconnected.

The PSU 140 may switch power supplied to the transceiver 110 to the power saving mode according to a control signal received from the controller 120. The reproduction unit 150 receives a control signal from the controller 120 and reproduces the broadcast data received by the transceiver 110 or the sound source or image stored in the storage unit 130. The user interface unit 160 may receive a control signal to reproduce the broadcast data or the sound source or image stored in the storage unit 130. If a request is input from the user via of the user interface unit 160, the controller 120 may process the input request first.

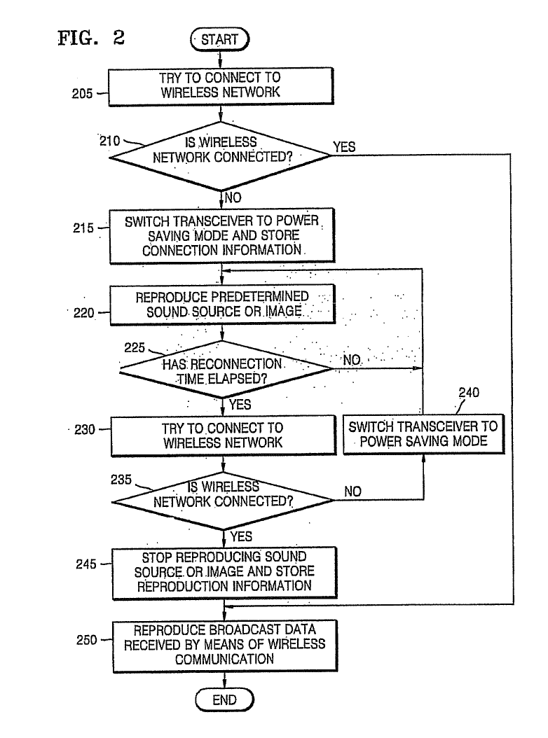

FIG. 2 is a flowchart of a process of receiving and reproducing broadcast data by wireless communication according to an example embodiment of the present invention. The process may be sequentially performed by the broadcast data reproduction apparatus 100 illustrated in FIG. 1. Thus, although not fully described, the contents relating to the broadcast data reproduction apparatus 100 also apply to the processes described below with respect to FIGS. 2-4.

The broadcast data reproduction apparatus 100 connects to a wireless network through the transceiver 110 and outputs audio or video in real-time using the reproduction unit 150. If the connection state of the wireless network is bad or disconnected when the broadcast data reproduction apparatus 100 moves into a shadow area, the broadcast data reproduction apparatus attempts to connect to the wireless network at block 205. The shadow area may be, for example, an area underneath a bridge, in a valley or forested area, or any location where wireless signals are unavailable due to a blockage or lack of coverage. The connection state may be determined by the controller 120 based on information on a reception ratio or sensitivity of broadcast data received by the transceiver 110.

The broadcast data reproduction apparatus 100 determines at block 210 whether the connection to the wireless network attempted at block 205 is successful. If the connection to the wireless network is successful, the process proceeds to block 250; otherwise, the process proceeds to block 215. If the connection to the wireless network is not successful, the process may proceed to block 215 after attempting to connect to the wireless network for a period of time or number of tries set by the user using the user interface unit 160 or set as default. The process may also proceed to block 215 without trying the reconnection any more. The broadcast data reproduction apparatus 100 according to another aspect of the invention may stop operating if the connection to the wireless network is not successful.

At block 215, the broadcast data reproduction apparatus 100 switches the transceiver 110 to the power saving mode. The controller 120 stores connection information (frequency, channel, URL, playlist, etc.) in an internal or external storage device when the wireless connection is disconnected and the transceiver 110 does not try to reconnect.

When the reconnection is being tried or the transceiver 110 is switched to the power saving mode, the broadcast data reproduction apparatus 100 informs the user that the reconnection is being tried by outputting the sound source or image to the reproduction unit 150 in operation 220. The sound source or image is stored in the internal or external storage device and may be set by the user in advance. For example, in order to inform the user that the reconnection is being attempted, the broadcast data reproduction apparatus 100 may output a call connection sound or a connection image to the reproduction unit 150. The sound source or image output to the reproduction unit 150 can be output by referring to a file location or medium defined by default, a file location or medium that stores an output sound source or image, or a stored playlist. The sound source or image output to the reproduction unit 150 may be selected or set by the user using the user interface unit 160, and in the case of the sound source, “random”, “repeat 1”, or “repeat all” can be set.

At block 225, the broadcast data reproduction apparatus 100 determines, based on a value set by the user or by default, whether a wireless communication reconnection time has elapsed. If the wireless communication reconnection time has not elapsed, the process proceeds to block 220. If the wireless communication reconnection time has elapsed, the process proceeds to block 230. The wireless communication reconnection time may correspond to the time for one or more sound sources or images stored in the internal or external storage device to be completely reproduced.

The broadcast data reproduction apparatus 100 attempts to connect to the wireless network again at block 230. The power saving mode of the transceiver 110 may be released before trying to connect to the wireless network. The attempt to connect to the wireless network may be performed for a pre-set time or by a pre-set number of attempts. The attempt to connect to the wireless network can be performed using the connection information stored at block 215.

The controller 120 determines at block 235 whether the attempt to connect to the wireless network is successful. If the attempt is not successful, the process proceeds to block 240. If the attempt is successful, the process proceeds to block 245. The controller 120 of the broadcast data reproduction apparatus switches the transceiver 110 to the power saving mode at block 240.

The broadcast data reproduction apparatus 100 stores reproduction information (medium type, file name, reproduced time, etc.) of a sound source or image being output to the reproduction unit 150 in the internal or external storage device, and stops reproducing the sound source or image being output to the reproduction unit 150 at block 245. The reproduction of the sound source or image may stop immediately after the attempt to connect to the wireless network is successful, or may stop after the sound source or image being currently reproduced is completely reproduced. The broadcast data reproduction apparatus 100 reproduces broadcast data received by means of wireless communication at block 250.

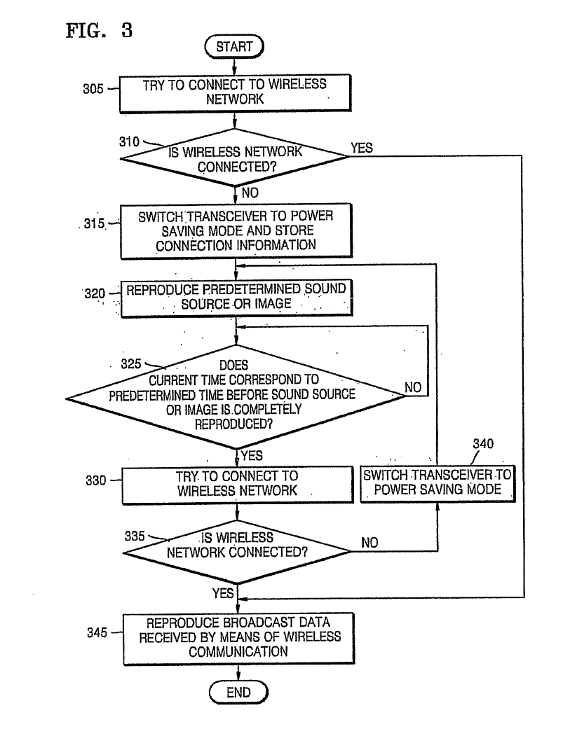

FIG. 3 is a flowchart of a process of receiving and reproducing broadcast data by means of wireless communication according to another example embodiment of the present invention. The broadcast data reproduction apparatus 100 connects to a wireless network through the transceiver 110 and outputs audio or video in real-time using the reproduction unit 150. If the connection state of the wireless network is bad or disconnected when the broadcast data reproduction apparatus 100 moves into a shadow area, the broadcast data reproduction apparatus 100 attempts to connect to the wireless network at block 305. The connection state is determined by the controller 120 based on information on a reception ratio or a sensitivity of broadcast data received by the transceiver 110.

The broadcast data reproduction apparatus 100 determines at block 310 whether the connection to the wireless network is successful. If the connection to the wireless network is successful, the process proceeds to block 345; otherwise, the process proceeds to block 315. The process may proceed to block 315 after attempting to connect to the wireless network during a time period or a number of attempts set by the user using the user interface unit 160 or set by default. Alternatively, the process may proceed directly to block 315 without attempting to reconnect any more. According to another aspect of the invention, if the attempt to connect is unsuccessful, the broadcast data reproduction apparatus may stop operating.

At block 315, the broadcast data reproduction apparatus 100 switches the transceiver 110 to the power saving mode. The controller 120 stores connection information (frequency, channel, URL, playlist, etc.) in an internal or external storage device when the wireless connection is disconnected and the transceiver 110 does not attempt to reconnect.

When the reconnection is being attempted or the transceiver 110 is switched to the power saving mode, the broadcast data reproduction apparatus 100 informs the user that the reconnection is being attempted at block 320. The broadcast data reproduction apparatus 100 informs the user by outputting the sound source or image stored in the internal or external storage device and set by the user in advance to the reproduction unit 150. For example, in order to inform the user that the reconnection is being attempted, the broadcast data reproduction apparatus 100 may output a call connection sound or a connection image to the reproduction unit 150. The sound source or image output to the reproduction unit 150 can be output by referring to a file location or medium defined as a default, a file location or medium in which an output sound source or image exists, or a stored playlist. The sound source or image output to the reproduction unit 150 may be selected or set by the user via the user interface unit 160, and in the case of the sound source, ‘random’, ‘repeat 1’, or ‘repeat all’ can be set.

The broadcast data reproduction apparatus 100 determines at block 325 whether the current time corresponds to a predetermined time before the sound source or image is completely reproduced, based on time information of the sound source or image. If the current time is prior to the predetermined time, the process repeats block 325. If the current time corresponds to the predetermined time, the process proceeds to block 330.

At block 330, the broadcast data reproduction apparatus 100 attempts to connect to the wireless network. The broadcast data reproduction apparatus 100 determines at block 335 whether the attempt to connect to the wireless network is successful. If the attempt is successful, the process proceeds to block 345. If the attempt is not successful, the process proceeds to block 340. The broadcast data reproduction apparatus switches the transceiver 110 to the power saving mode at block 340.

At block 345, the broadcast data reproduction apparatus 100 outputs the broadcast data after the sound source or image reproduced in operation 320 is completely reproduced using the reproduction unit 150. The broadcast data may be received by wireless communication using the connection information (frequency, channel, URL, playlist, etc.) stored in the internal or external storage device immediately after the broadcast data reproduction apparatus moves into the shadow area.

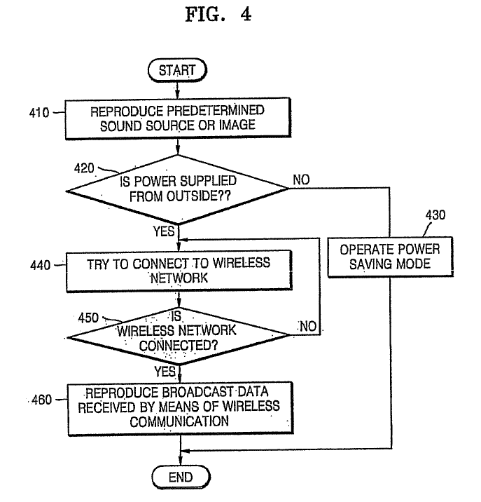

FIG. 4 is a flowchart of a process of receiving and reproducing broadcast data by means of wireless communication according to another example embodiment of the present invention. The broadcast data reproduction apparatus connects to a wireless network through the transceiver 110 and outputs audio or video in real-time using the reproduction unit 150. If the connection state of the wireless network is bad or disconnected when the broadcast data reproduction apparatus moves into a shadow area, the broadcast data reproduction apparatus informs the user that a reconnection is being attempted at block 410. The user may be informed by outputting a sound source or image stored in an internal or external storage device and set by the user in advance. The connection state is determined by the controller 120 based on information on a reception ratio or sensitivity of broadcast data received by the transceiver 110.

The controller 120 of the broadcast data reproduction apparatus 100 determines at block 420 whether power supplied to the broadcast data reproduction apparatus is external power or internal power (e.g. battery power). If the power is supplied from the outside, the process proceeds to block 440. If the power is supplied from the inside, the process proceeds to block 430.

At block 430, the broadcast data reproduction apparatus 100 operates in the power saving mode as illustrated in FIG. 2 or FIG. 3. The broadcast data reproduction apparatus 100 attempts to connect to the wireless network at block 440.

The broadcast data reproduction apparatus 100 determines at block 450 whether the attempt to connect to the wireless network is successful. If the attempt is successful, the process proceeds to block 460. If the attempt is not successful, the process proceeds to block 440.

At block 460, the broadcast data reproduction apparatus 100 reproduces the broadcast data using the reproduction unit 150 after the sound source or image reproduced in operation 410 is completely reproduced or immediately after the reconnection is successful. The broadcast data may be received using the connection information (frequency, channel, URL, playlist, etc.) stored in the internal or external storage device immediately after the broadcast data reproduction apparatus moves into the shadow area.

The present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, DVDs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, according to aspects of the present invention, when broadcast data is received and reproduced by means of wireless communication, if it is difficult to receive the broadcast data while operating in a shadow area, a transceiver for the wireless communication is switched to a power saving mode and a predetermined sound source or image is reproduced until the wireless communication is reconnected, so that a sound source or image can be continuously provided to a user, and power can be saved.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, external power, such as power supplied from an electric power grid, external generator, or the like, is an example of a power supply having a substantially unlimited capacity. Similarly, a battery (internal or external) is an example of a power supply having a limited capacity. The power supply unit 140 may also receive power supplied from an external source. Accordingly, it is intended, therefore, that the present invention not be limited to the various example embodiments disclosed, but that the present invention includes all embodiments falling within the scope of the appended claims.

What is claimed is:

1. A method of receiving and reproducing broadcast data by wireless communication, the method comprising:
switching to a power saving mode which uses less electrical power than a mode employed while performing wireless communication, if a wireless network providing the wireless communication is disconnected, and
reproducing a predetermined sound source or image to a user in the power saving mode.

2. The method of claim 1, further comprising:
exiting the power saving mode after a predetermined time elapses;
attempting to reconnect to the wireless network; and
reproducing the broadcast data received by means of wireless communication if the wireless network is reconnected.

3. The method of claim 2, wherein the attempting to reconnect comprises trying to reconnect to the wireless network for a pre-set time period.

4. The method of claim 1, wherein the attempting to reconnect comprises attempting to reconnect to the wireless network a pre-set number of times.

5. The method of claim 1, wherein attempting to reconnect comprises attempting to reconnect to the wireless network at a predetermined time before the sound source or the image provided to the user is completely reproduced.

6. The method of claim 1, wherein the switching to the power saving mode comprises:
determining whether power supplied to an apparatus executing the method is supplied from a power supply unit having a limited capacity if the wireless network is disconnected; and
attempting to reconnect to the wireless network if the power is supplied from a power supply unit having a substantially unlimited capacity; and
switching to the power saving mode if the power is supplied from a power supply unit having a limited capacity.

7. The method of claim 1, wherein:
the switching to the power saving mode comprises, storing connection information required to re-receive the broadcast data being received if the wireless network is disconnected; and
the attempt to reconnect to the wireless network comprises reconnecting the disconnected wireless communication using the stored connection information.

8. The method of claim 1, further comprising
storing reproduction information required when the sound source or image provided to the user is reproduced again if the wireless network is reconnected.

9. The method of claim 7, wherein the connection information comprises a frequency, a channel a Uniform Resource Locator (URL), and a playlist.

10. The method of claim 8, wherein the reproduction information comprises a medium type, a file name, and a reproduced time.

11. An apparatus to receive and reproduce broadcast data by wireless communication, the apparatus comprising:
a controller to switch to a power saving mode that uses less electrical power than a mode employed while performing wireless communication, when a wireless network providing the wireless communication is disconnected; and
a reproduction unit to reproduce a predetermined sound source or image to a user while the apparatus is operating in the power saving mode.

12. The apparatus of claim 11, wherein, after a predetermined time elapses, if the power saving mode is exited and the wireless network is reconnected, the reproduction unit reproduces the broadcast data received by the wireless communication.

13. The apparatus of claim 11, wherein the controller attempts to reconnect to the wireless network for a pre-set time period.

14. The apparatus of claim 11, wherein the controller attempts to reconnect to the wireless network a pre-set number of times.

15. The apparatus of claim 11, wherein the controller attempts to reconnect to the wireless network at a predetermined time before the sound source or image provided to the user is completely reproduced.

16. The apparatus of claim 11, wherein:
the controller determines whether power supplied to the apparatus is supplied from a power supply unit having a limited capacity if the wireless network is disconnected; and
if the power is supplied from a power supply unit having a substantially unlimited capacity, the controller attempts to reconnect to the wireless network, and if the power is supplied from a power supply unit having a limited capacity, the controller switches to the power saving mode.

17. The apparatus of claim 11, further comprising:
a storage unit to store connection information required to re-receive the broadcast data being received if the wireless network is disconnected;
wherein, when the controller attempts to reconnect to the wireless network, the controller reconnects to the wireless network using the stored connection information.

18. The apparatus of claim 11, further comprising:
a storage unit to store reproduction information required when the sound source or image provided to the user is reproduced again if the wireless network is reconnected.

19. The apparatus of claim 17, wherein the connection information comprises a frequency, a channel, a Uniform Resource Locator (URL), and a playlist.

20. The apparatus of claim 18, wherein the reproduction information comprises a medium type, a file name, and a reproduced time.

21. A computer readable recording medium storing a computer readable program for executing the method of claim 1.

22. A method of conserving power in a broadcast data communication apparatus receiving broadcast data via wireless communication when the wireless network is disconnected or the wireless communication provided by the wireless network is bad, the method comprising:
informing a user of a broadcast data communication apparatus that a wireless network is disconnected or that wireless communication provided by the wireless network is bad;
determining whether the broadcast data communication apparatus is supplied with power from a source having substantially unlimited capacity or from a source having limited capacity;
operating the broadcast data communication apparatus in a power saving mode that consumes less power than a mode employed while performing wireless communication, if the power is supplied from the source having limited capacity;
attempting to reconnect to the wireless network if the power is supplied from the source having substantially unlimited capacity; and
reproducing broadcast data received via the wireless communication if the attempt to reconnect to the wireless network is successful.

23. A broadcast data reproduction apparatus that receives broadcast data over a wireless network via wireless communication, the apparatus comprising:
a transceiver to communicate with a wireless network;
a power supply unit to supply power to the broadcast data reproduction apparatus;
a reproducing unit to reproduce a predetermine image or sound source; and
a controller to control the transceiver to enter a power saving mode if a connection to the wireless network is disconnected or the quality of the wireless communication is bad and to control the reproducing unit to reproduce the predetermined image or sound source if the connection to the wireless network is disconnected or the quality of the wireless communication is bad;
wherein the power saving mode is a mode that consumes less power than when performing wireless communication via the transceiver.
